(19) United States
(12) Patent Application Publication
(10) Pub. No.: US 2013/0009814 A1
(43) Pub. Date: Jan. 10, 2013

(54) AUTONOMOUS SYSTEM FOR POSITIONING BY PSEUDOLITES IN A CONSTRAINED ZONE AND METHOD OF IMPLEMENTATION

(75) Inventor: Mathias Van Den Bossche, Goyrans (FR)

(73) Assignee: THALES, NEUILLY SUR SEINE (FR)

(21) Appl. No.: 13/634,453

(22) PCT Filed: Feb. 3, 2011
(86) PCT No.: PCT/EP2011/051525

§ 371 Date: Sep. 12, 2012

(30) Foreign Application Priority Data
Mar. 12, 2010 (FR) 1000999

(51) Int. Cl. G01S 19/11

(52) U.S. Cl. 342/357.48

(57) ABSTRACT

A system for positioning an object in a constrained zone, including: a set of pseudolites distributed in the constrained zone and each presenting a spreading code corresponding to the spreading code of a satellite belonging to a constellation of satellites of a satellite navigation system, the constellation of satellites including a first set of satellites and a second set of satellites of disjoint visibility, and a receiver on the object to be localized, the pseudolites being distributed in the constrained zone such that, at any point of the constrained zone, the receiver can acquire the positioning signals of at least two pseudolites presenting spreading codes corresponding to a satellite of the first set, and to a satellite of the second set, such that the receiver detects the impossibility of the acquired signals being transmitted by satellites of the constellation of satellites and determines the acquired signals were transmitted by pseudolites.

The present invention relates to a system allowing an object equipped with a suitable receiver to determine its position in a constrained zone.

More particularly, the positioning system according to the present invention is based on the use of pseudolites.

As is known, pseudolites, contraction of pseudo-satellites, are devices operating according to the same principles as satellites belonging to constellations of satellites implemented in the context of Global Navigation Satellite Systems (GNSS), such as the Global Positioning System (GPS), or the Galileo system. Unlike satellites, pseudolites are deployed on the ground. Typically, they can be distributed in a building, and in a general manner, in constrained zones.

The general principle of systems for positioning by pseudolites lies in the fact that said pseudolites transmit positioning signals of which the format is identical or similar to that of the messages transmitted by the satellites of a satellite navigation system. For this purpose, an identifier of the same family as that of a satellite is generally allocated to each pseudolite. In the context of constellations of satellites, these identifiers are called spreading codes, as is known to the person skilled in the art.

The range of the signals transmitted by the pseudolites is variable; it depends on their power and their use. Objects equipped with suitable receivers can acquire these positioning signals. As in the case of a conventional satellite navigation system, a calculation of distances between said receiver and the pseudolites of which it has acquired the signals, then a position calculation through triangulation, allow the position of the receiver to be determined. The principle of positioning through triangulation is known: it involves determining the position of a receiver as being at the intersection of spheres with the transmitters as their centre and the distance between the receiver and transmitters as their radius. The calculations can be carried out in an on-board manner, by the object itself, or in a delocalized manner by a computer.

As seen, the systems for positioning by pseudolites are generally deployed in “constrained” zones. These constrained zones can typically be buildings inside which the positioning signals transmitted by satellites in orbit around the Earth cannot be acquired due to masking by the walls, ceilings, etc. It may simply involve zones that are not covered by the satellite navigation system concerned. In a general manner, a constrained zone will be defined as being a zone in which positioning signals transmitted by satellites cannot be correctly acquired. Conversely, the term “open zone” refers to zones where positioning signals transmitted by satellites can be acquired by a suitable receiver. Moreover, satellites of which a receiver can theoretically receive positioning signals due to the appropriate relative position between said satellites and said receiver are referred to as “visible” to the receiver, whereas the other satellites of the constellation are referred to as “non-visible”. These specific terms “visible” and “non-visible” are usable in the case of pseudolites, the appropriateness of the relative positions being determined in this case not by the geometry of the terrestrial globe, but by the local maskings which can adversely affect the signals of the pseudolites.

The definitions given above of “constrained zone”, “open zone”, “visible” satellite or pseudolite and “non-visible” satellite or pseudolite apply to the entire remainder of the description and to the claims.

It is known that satellite positioning systems can have a server referred to as the assistance server, the role of which is to send information to the receiver concerning the constellation of satellites, such as the position of the visible satellites and other aids facilitating the processing of the positioning signals. A system for positioning by pseudolites can also have an assistance server of this type. In “assisted” mode, the assistance server can calculate the position of the receiver on the basis of the calculations of pseudo-distances which the latter supplies to it.

In the context of the present invention, the positioning system can function perfectly in a constrained zone without receiving information from an assistance server.

Known systems for positioning by pseudolites present a certain number of defects. In particular, they do not allow the transition without assistance from a constrained zone to an open zone and vice versa, in a continuous and autonomous manner. Moreover, they do not generally allow a cold start-up without assistance or without knowledge of the initial position of the receiver. Consequently, known systems generally involve the use of receivers designed specifically for an operation in a constrained zone and the acquisition of positioning signals transmitted by pseudolites.

In other cases, they require an intervention on the receiver so that the latter begins to acquire signals transmitted by pseudolites. In any event, the modes of operation in a constrained zone and in an open zone are not generally compatible, in the sense that they cannot be simultaneously active.

Furthermore, a major constraint to be taken into account lies in the fact that the spreading codes of the satellites belonging to constellations of satellites are reserved for said satellites. It is not possible to use other codes without having to design specific receivers, since conventional receivers are designed to acquire positioning signals originating from said satellites.

A known solution aiming to overcome these problems consists in allocating to the pseudolites spreading codes of satellites that are non-visible from the point where the receiver is located. However, the problem persists entirely for receivers which do not benefit from assistance data transmitted by an assistance server, and which do not know their initial position on start-up of the receiver.

A receiver of this type, not operating in assisted mode and not knowing its initial position, is, according to the prior art, incapable of recognizing that it is dealing with pseudolites. Consequently, it does not acquire the positioning signals transmitted by the pseudolites provided in the constrained zone in which it is located and it is impossible for it to determine its position.

One object of the invention is to solve this technical problem by proposing a system for positioning by pseudolites suitable for operating with standard receivers and able to acquire in a transparent manner, from the point of view of the receiver, positioning signals transmitted by pseudolites as if this involved positioning signals transmitted by satellites belonging to a constellation of satellites of a satellite navigation system, to recognize that it is dealing with pseudolites without benefiting from data supplied by an assistance server.

Thus, the subject of the invention is a system for positioning an object in a zone of interest presenting a constrained zone, said system including:

a set of pseudolites distributed in said constrained zone and each presenting a spreading code corresponding to the spreading code of a satellite belonging to a constellation of satellites of a satellite navigation system, said constellation of satellites including a first set of satellites and a second set of satellites, the satellites of the first and the second sets of satellites being non-visible from the zone of interest, and the first and the second sets of satellites being of disjoint visibility, in such a way that any one of the satellites of the first set and any one of the satellites of the second set cannot be simultaneously visible from a point situated on the surface of the Earth, in the sense that the satellites of the first and the second sets present relative positions such that signals transmitted by satellites of the first set and signals transmitted by satellites of the second set cannot be received simultaneously by a receiver placed at a point situated on the surface of the Earth, each pseudolite furthermore transmitting a positioning signal,
and a receiver situated on the object to be localized,
in which said pseudolites are distributed in the constrained zone in such a way that, at any point of the constrained zone, it is possible for the receiver of the object to acquire the positioning signals of at least two pseudolites presenting spreading codes corresponding, for the one, to a satellite of the first set, and, for the other, to a satellite of the second set, in such a way that the receiver receiving these positioning signals detects the impossibility of them being signals transmitted by satellites of the constellation of satellites and consequently determines in a totally autonomous manner that it is receiving positioning signals transmitted by pseudolites.

According to one embodiment of the invention, the constellation of satellites having N sets of satellites, N been greater than or equal to 3, non-visible from the zone of interest, and of disjoint visibility, in such a way that any one of the satellites of any one of the N sets of satellites cannot be visible at the same time as any one of the satellites of any one of the other sets of satellites among the N sets of satellites from a point situated on the surface of the Earth, the pseudolites are distributed in the constrained zone in such a way that, at any point of the constrained zone, it is possible for the receiver of the object to acquire the positioning signals of at least three pseudolites presenting spreading codes corresponding to satellites belonging to three distinct sets of satellites among the N sets of satellites.

Advantageously, the positioning signals transmitted by the pseudolites can broadcast almanacs identical to those of the satellites of the constellation of satellites, in such a way as to provide a continuity of service at the transition between a constrained zone equipped with a set of pseudolites and an open zone without pseudolites but allowing the reception of positioning signals transmitted by the satellites of the constellation, and, vice versa, in such a way as to provide a continuity of service at the transition between an open zone and a constrained zone.

Advantageously, a server connected to the set of pseudolites is configured to allocate dynamically to each pseudolite a suitable spreading code chosen from codes allocated to the satellites that are non-visible from the zone of interest.

The receiver situated on the object to be positioned can present at least one of the following operating modes:

a “constrained zone” operating mode when the receiver is located in a zone in which it is able to receive only positioning signals transmitted by pseudolites;
an “open zone” operating mode when the receiver is located in a zone in which it is able to receive only positioning signals transmitted by satellites belonging to a constellation of satellites of a satellite navigation system;
a “hybrid zone” operating mode when the receiver is located in a zone in which it is able to receive both positioning signals transmitted by pseudolites and positioning signals transmitted by satellites belonging to a constellation of satellites of a satellite navigation system.

The system is advantageously suitable for switching from one operating mode to another.

Advantageously, the receiver selects its operating mode in an automatic manner.

Advantageously, the positioning system according to the invention can include means to force the operating mode of the receiver.

Advantageously, the operating mode of the receiver can be chosen manually.

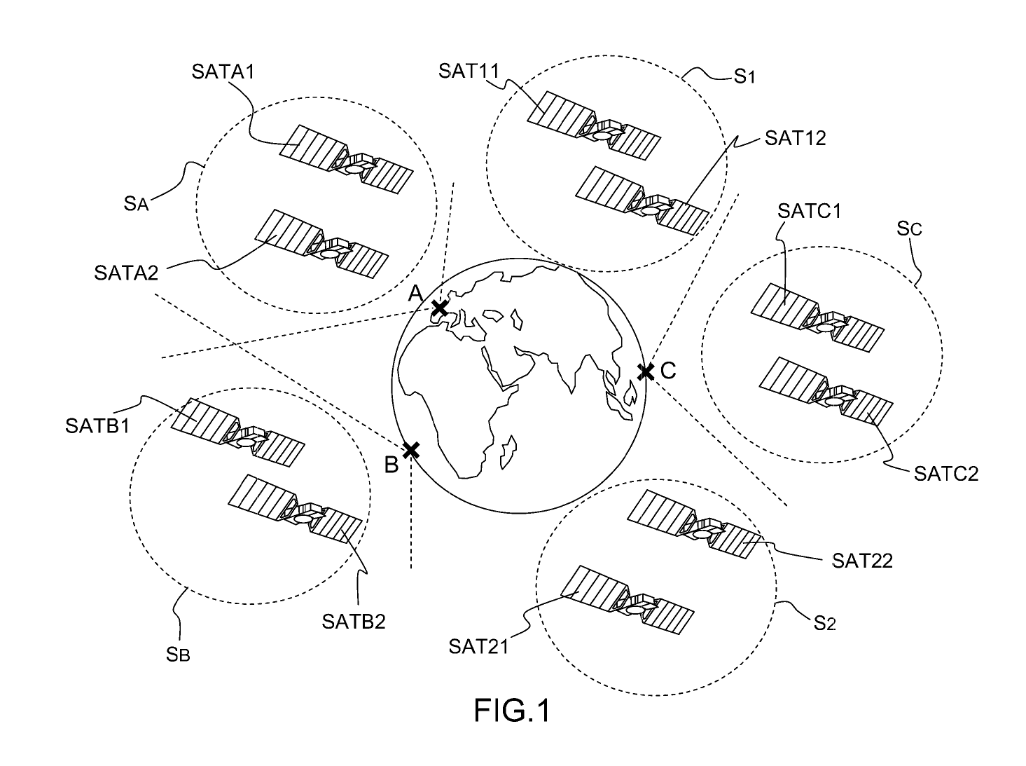

Other characteristics and advantages of the invention will become evident from the description that follows with reference to the attached FIG. 1, which shows schematically a constellation of satellites in orbit around the Earth forming part of a satellite navigation system.

More precisely, FIG. 1 shows a constellation of satellites including sub-sets of satellites SA, SB, SC, S1, S2. The set SA represents all of the satellites SATA1, SATA2 visible from a receiver located at point A, on the surface of the Earth. Similarly, the set SB represents all of the satellites SATB1, SATB2 visible from the receiver located at point B and the set SC represents all of the satellites SATC1, SATC2 visible from the receiver located at point C.

As shown in FIG. 1, for a given constellation of satellites, forming part of a satellite navigation system, sub-sets of satellites, S1, S2, can be defined combining satellites, SAT11, SAT12, respectively SAT21, SAT22, not simultaneously visible to a receiver located on the surface of the Earth. Thus, in the example of a configuration of a constellation of satellites shown in FIG. 1, the satellites SAT11 and SAT12 of the set S1 and the satellites SAT21 and SAT22 of the set S2 cannot be seen simultaneously, notably here, by way of illustration, from the points A, B, or C.

The basic principle of the invention consists in exploiting the fact that the constellation of satellites on which the system for positioning by pseudolites is based includes at least two sub-sets of satellites non-visible from the zone covered by the pseudolites, for example, in FIG. 1, S1 and S2, of which the respective satellites are never simultaneously visible from the Earth.

In order to lure the receiver of the object that is to be positioned, the invention proposes an original configuration of the set of pseudolites provided in the constrained zone concerned. Thus, the allocation of spreading codes to the pseudolites is implemented in such a way that, at any point of the constrained zone covered by said set of pseudolites, a receiver started up without knowing its initial position detects at least two pseudolites presenting spreading codes belonging to satellite sub-sets S1, S2 of which the respective satellites cannot be simultaneously visible. The sub-sets S1 and S2 are said to be of disjoint visibility. The pseudolite is then simply programmed so that, in this context, it determines the fact that it is located in the presence of pseudolites. It is then capable of acquiring and decoding the positioning signals that it receives from the visible pseudolites. The position calculations can then be carried out either in an on-board manner by the receiver or in a delocalized manner by a dedicated computer with which the receiver can communicate.

From a hardware point of view, the receiver can perfectly well be a standard receiver, such as a GPS receiver, for example. Only a simple adaptation of the on-board software of this receiver must be carried out, as explained above. It does not need assistance data, as (i) it uses only standard satellite codes and (ii) it can determine that it is dealing with pseudolites when this is the case.

The system according to the invention consequently operates on the basis of standard receivers and a set of pseudolites distributed in a constrained zone under consideration.

On start-up, the receiver, operating in non-assisted mode, seeks to acquire all of the satellites of the constellation, i.e. all of the spreading codes allocated to the satellites.

In an optional manner, the receiver can be manually forced to switch to a “constrained zone” operating mode, in which it seeks exclusively to acquire pseudolites. According to a different option, after having detected in an automatic manner the presence of pseudolites, the receiver can propose to a user to switch to “constrained zone” operating mode, said user having the option of refusing a switchover of this type.

A spreading code is allocated to the pseudolites in a dynamic manner by a dedicated server. As explained above, this dynamic allocation of spreading codes to the pseudolites is carried out in such a way that, at any point of the constrained zone, the visible pseudolites present satellite spreading codes belonging to at least two sub-sets S1, S2 of disjoint visibility.

Moreover, the pseudolites preferably broadcast, within the positioning messages that they transmit, almanacs identical to those of the satellites of the constellation of satellites, in such a way as to facilitate the continuity of the positioning service at the transition between a constrained zone equipped with pseudolites and an open zone.

It must furthermore be noted that the positioning information present in the positioning signals transmitted by the pseudolites can be simpler than that transmitted by true satellites; consequently, the freed bandwidth can be profitably used to broadcast other information to the pseudolites, such as, for example, the positions of the adjacent pseudolites or the identifier of their spreading code.

In operation, the behavior of the system according to the invention is as follows:

In an open environment: the receiver operates in a conventional manner since it receives signals transmitted by satellites belonging to a constellation of satellites forming part of a satellite navigation system. The receiver may possibly, in a sporadic fashion, seek to acquire positioning signals of theoretically non-visible satellites; it could thus detect the presence of pseudolites.
At start-up in a constrained zone, the receiver seeking to acquire all of the satellites of the constellation detects—at least—two spreading codes corresponding to satellites that should not be visible simultaneously; it can then switch to a “constrained zone” operating mode to acquire and decode the positioning signals transmitted by the visible pseudolites; alternatively, the receiver only proposes the switching to the user.
At the transition between an open zone and a constrained zone, the receiver can detect a massive loss of visible satellites; in this case, it can switch directly to “constrained zone” operating mode; alternatively, the receiver detects the presence of pseudolites thanks to the sporadic acquisition procedure described above. Optionally, the receiver can continue to acquire and exploit the positioning signals transmitted by satellites, insofar as it receives them.
At the transition between a constrained zone and an open zone, the receiver can detect a massive loss of visible pseudolites and switch directly to “open zone” operating mode; alternatively, the receiver detects the presence of visible satellites thanks to a sporadic acquisition procedure. Optionally, the receiver can continue to acquire and exploit the positioning signals transmitted by pseudolites, insofar as it receives them.

In summary, the main advantage of the invention is to propose a system for positioning by pseudolites operating on the basis of standard receivers, and allowing a continuity of service between a constrained zone and an open zone, and vice versa. Above all, the system for positioning by pseudolites according to the invention is suitable for operating without assistance data, including in the context of a cold start-up of the receiver in a constrained zone, without knowledge of the initial position.

1. A system for positioning an object in a zone of interest presenting a constrained zone, said system including:
a set of pseudolites distributed in said constrained zone and each presenting a spreading code corresponding to the spreading code of a satellite belonging to a constellation of satellites of a satellite navigation system, said constellation of satellites including a first set of satellites and a second set of satellites, the satellites of the first and the second sets of satellites being non-visible from the zone of interest, and the first and the second sets of satellites being of disjoint visibility, such that any one of the satellites of the first set and any one of the satellites of the second set cannot be simultaneously visible from a point situated on the surface of the Earth, in that the satellites of the first and the second sets present relative positions such that signals transmitted by satellites of the first set and signals transmitted by satellites of the second set cannot be received simultaneously by a receiver placed at a point situated on the surface of the Earth, each pseudolite furthermore transmitting a positioning signal; and
a receiver situated on the object to be localized,
wherein the pseudolites are distributed in the constrained zone such that, at any point of the constrained zone, the receiver on the object can acquire the positioning signals of at least two pseudolites presenting spreading codes corresponding, for the one, to a satellite of the first set, and, for the other, to a satellite of the second set, such that the receiver on the object detects the impossibility of the acquired positioning signals being signals transmitted by satellites of the constellation of satellites and consequently determines autonomously that the acquired positioning signals were transmitted by pseudolites.

2. The system as claimed in claim 1, wherein
the constellation of satellites has N sets of satellites, N being greater than or equal to 3, non-visible from the zone of interest, and of disjoint visibility, such that any one of the satellites of any one of the N sets of satellites cannot be visible at the same time as any one of the satellites of any one of the other sets of satellites among the N sets of satellites from a point situated on the surface of the Earth; and
the pseudolites are distributed in the constrained zone such that, at any point of the constrained zone, it is possible for the receiver on the object to acquire the positioning signals of at least three pseudolites presenting spreading codes corresponding to satellites belonging to three distinct sets of satellites among the N sets of satellites.

3. The system as claimed in claims 1, wherein
the positioning signals transmitted by the pseudolites broadcast almanacs identical to those of the satellites of the constellation of satellites, providing continuity of service at a transition between a constrained zone equipped with a set of pseudolites and an open zone without pseudolites but allowing the reception of positioning signals transmitted by the satellites of the constellation, and providing continuity of service at a transition between the open zone and the constrained zone.

4. The system as claimed in claim 1, further comprising a server connected to the set of pseudolites configured to allocate dynamically to each pseudolite a suitable spreading code chosen from codes allocated to the satellites that are non-visible from the zone of interest.

5. The system as claimed in claim 1, wherein the receiver situated on the object to be positioned presents at least one of the following operating modes:
a “constrained zone” operating mode when the receiver is located in a zone in which the receiver is able to receive only positioning signals transmitted by pseudolites;
an “open zone” operating mode when the receiver is located in a zone in which the receiver is able to receive only positioning signals transmitted by satellites belonging to a constellation of satellites of a satellite navigation system; and
a “hybrid zone” operating mode when the receiver is located in a zone in which the receiver is able to receive both positioning signals transmitted by pseudolites and positioning signals transmitted by satellites belonging to a constellation of satellites of a satellite navigation system.

6. The system as claimed in claim 5, wherein the system is suitable for switching from one operating mode to another.

7. The system as claimed in claim 5, wherein the receiver is configured to select its operating mode in an automatic manner.

8. The system as claimed in claim 7, further comprising means to force the operating mode of the receiver.

9. The system as claimed in claim 5, wherein the operating mode of the receiver may be chosen manually.
